(19) United States
(12) Patent Application Publication
(10) Pub. No.: US 2025/0249958 A1
(43) Pub. Date: Aug. 7, 2025

(54) BATTERY MOUNTING STRUCTURE

(71) Applicant: TOYOTA JIDOSHA KABUSHIKI KAISHA, Toyota-shi (JP)

(72) Inventor: Shinya GOITSUKA, Nisshin-shi (JP)

(73) Assignee: TOYOTA JIDOSHA KABUSHIKI KAISHA, Toyota-shi (JP)

(21) Appl. No.: 18/976,722

(22) Filed: Dec. 11, 2024

(30) Foreign Application Priority Data
Feb. 2, 2024 (JP) 2024-015154

(51) Int. Cl. B62D 21/15; B60R 16/04; H01M 50/242; H01M 50/249

(52) U.S. Cl. CPC B62D 21/157; B60R 16/04; H01M 50/242; H01M 50/249; H01M 2220/20

(57) ABSTRACT

A battery mounting structure includes: a vehicle frame having a hollow structure extending along a front-rear direction of a vehicle on both sides of the vehicle; a plurality of battery modules arranged inside the vehicle frame and arranged along the front-rear direction and a width direction orthogonal to the front-rear direction; a battery cross portion extending along the width direction in the vehicle frame; an energy absorption portion arranged outside the vehicle frame in the width direction, the energy absorption portion being configured to absorb energy of a collision on a side of the vehicle; and a first portion arranged between the battery cross portion and the vehicle frame to at least partially overlap both of the battery cross portion and the energy absorption portion when projected in the width direction.

The present application claims priority to and incorporates by reference the entire contents of Japanese Patent Application No. 2024-015154 filed in Japan on Feb. 2, 2024.

### BACKGROUND

This disclosure relates to a battery mounting structure.

JP 2023-046719 A discloses a mounting structure of a battery pack in which an energy absorption portion is disposed below a skeleton portion of a vehicle.

In the configuration of JP 2023-046719 A, a load applied to the energy absorption portion due to a collision on a side of the vehicle is supported by a battery cross portion disposed in a housing case of the battery pack. At this time, if a position where the energy absorption portion extends in a width direction of the vehicle and a position where the battery cross portion extends are displaced in the width direction of the vehicle, the energy absorption portion is rotationally deformed, so that an absorption efficiency of energy of the collision is not good.

Further, the energy absorption portion may be disposed outside the skeleton portion of the vehicle, and the load applied to the energy absorption portion due to the collision on the side of the vehicle may be supported by the skeleton portion. In this case, since front and rear ends of the skeleton portion are supported by vehicle cross portions arranged at the front and the rear of the vehicle, a distance between support points is long. Therefore, it is necessary to secure a bending strength of the skeleton portion, and the mass of the skeleton portion and the cost for manufacturing the skeleton portion increase.

Therefore, there is a need for a battery mounting structure capable of improving energy absorbing performance with a simple configuration.

### SUMMARY

According to one aspect of the present disclosure, a battery mounting structure includes: a vehicle frame having a hollow structure extending along a front-rear direction of a vehicle on both sides of the vehicle; a plurality of battery modules arranged inside the vehicle frame and arranged along the front-rear direction and a width direction orthogonal to the front-rear direction; a battery cross portion extending along the width direction in the vehicle frame; an energy absorption portion arranged outside the vehicle frame in the width direction, the energy absorption portion being configured to absorb energy of a collision on a side of the vehicle; and a first portion arranged between the battery cross portion and the vehicle frame to at least partially overlap both of the battery cross portion and the energy absorption portion when projected in the width direction.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram illustrating a schematic configuration of a vehicle including a battery mounting structure according to an embodiment;

FIG. 2 is a cross-sectional view corresponding to a A-A line of FIG. 1;

FIG. 3 is a perspective view of battery modules; and

FIG. 4 is a perspective view of a battery frame.

### DETAILED DESCRIPTION

A battery mounting structure according to an embodiment of the present disclosure will be described with reference to the drawings. Incidentally, constituent elements in the following embodiments include elements that can be easily replaced by a person skilled in the art or elements that are substantially the same.

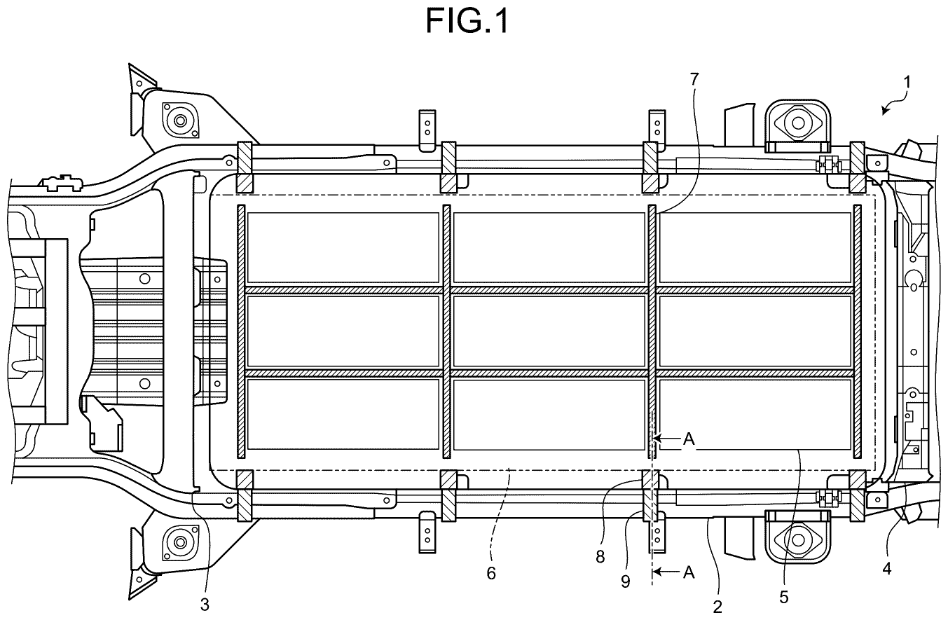

FIG. 1 is a diagram illustrating a schematic configuration of a vehicle including a battery mounting structure according to an embodiment. In FIG. 1, a front-rear direction of a vehicle 1 corresponds to a vertical direction of a paper surface on which the schematic configuration of the vehicle of FIG. 1 is drawn, and a width direction of the vehicle 1 corresponds to a left-right direction of the paper surface. The vehicle 1 includes a vehicle frame 2, vehicle cross portions 3 and 4, a plurality of battery modules 5, a battery frame 6, battery cross portions 7, a first portion 8, and a second portion 9.

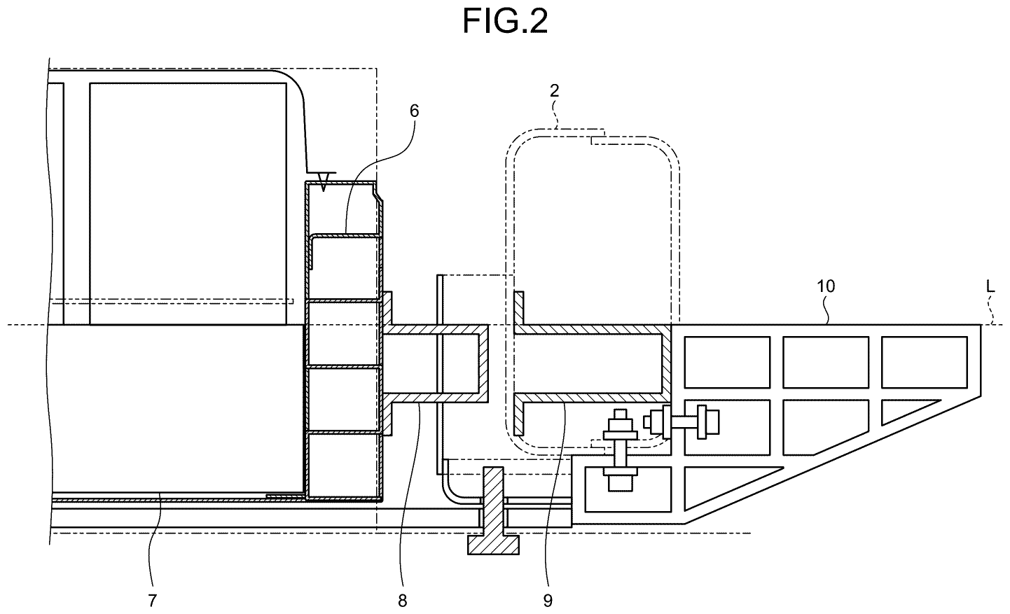

FIG. 2 is a cross-sectional view corresponding to a A-A line of FIG. 1. The vehicle 1 includes an Energy Absorption (EA) portion 10.

The vehicle frame 2 extends along the front-rear direction of the vehicle 1 on both sides of the vehicle 1. The vehicle frame 2 has a hollow structure formed by processing a plate-shaped member made of metal or an alloy into a columnar shape.

The vehicle cross 3 extends along the width direction of the vehicle 1 at the front of the vehicle 1.

The vehicle cross portion 4 extends along the width direction of the vehicle 1 at the rear of the vehicle 1.

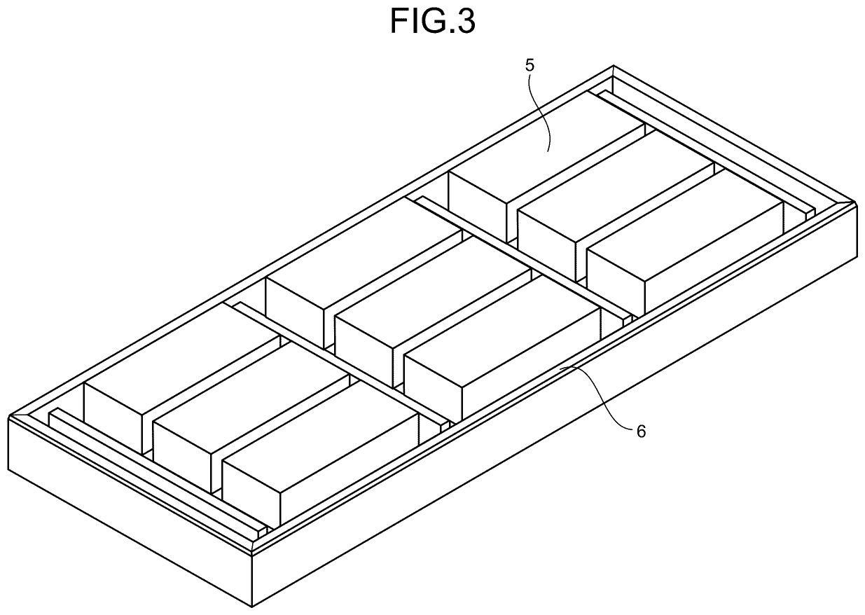

The battery modules 5 are disposed inside the vehicle frame 2 and are arranged along the front-rear direction and the width direction. FIG. 3 is a perspective view of the battery modules. In the example of FIG. 3, the battery modules 5 are arranged in three rows along the front-rear direction and in three rows along the width direction.

The battery frame 6 houses the battery modules 5.

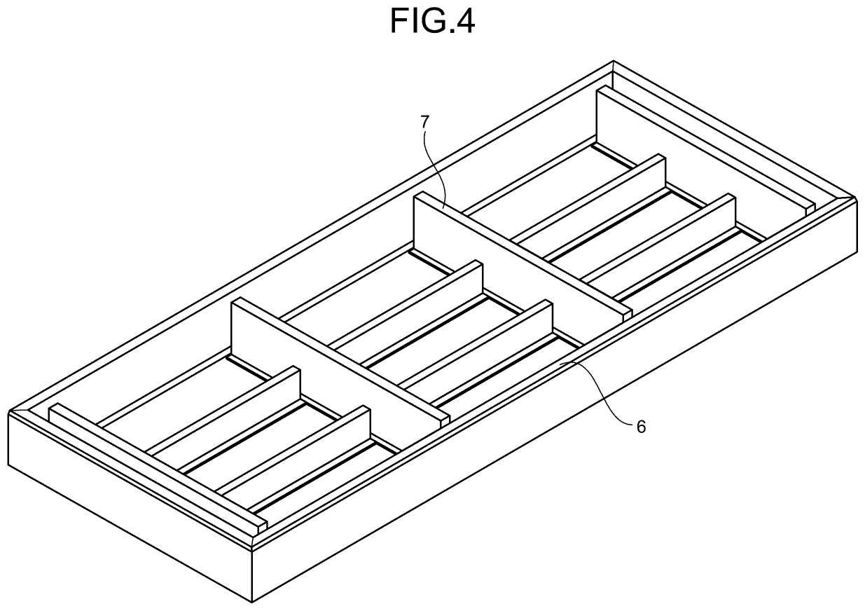

The battery cross portions 7 are arranged inside the vehicle frame 2 along the front-rear direction and the width direction. FIG. 4 is a perspective view of a battery frame. In the example of FIG. 4, two battery cross portions 7 extending along the front-rear direction and four battery cross portions 7 extending along the width direction are illustrated.

Returning to FIG. 2, the first portion 8 is disposed between the battery cross portion 7 and the vehicle frame 2, and at least partially overlaps the battery cross portion 7 and the EA portion 10 when projected in the width direction. The first portion 8 includes a convex portion protruding toward the outside of the vehicle 1 in the width direction and a flange portion extending upwardly and downwardly from the convex portion, and the flange portion is fixed to an inner wall surface of the battery frame 6 by welding or the like. Further, as indicated by a broken line L in FIG. 2, it is preferable that a ridge line along an upper end portion of the first portion 8 in the width direction coincides with a ridge line along an upper end portion of each of the battery cross portion 7 and the EA portion 10.

The second portion 9 is disposed in the hollow structure of the vehicular frame 2, and at least partially overlaps with the battery cross portion 7 and the EA portion 10 when projected in the width direction. The second portion 9 includes a convex portion protruding toward the outside of the vehicle 1 in the width direction and a flange portion extending upwardly and downwardly from the convex portion, and the flange portion is fixed to an inner wall surface of the vehicle frame 2 by welding or the like. Further, as indicated by the broken line L in FIG. 2, it is preferable that a ridge line along an upper end portion of the second portion 9 in the width direction coincides with the ridge line along the upper end portion of each of the battery cross portion 7 and the EA portion 10.

The convex portion of the first portion 8 and the convex portion of the second portion 9 are positioned so as to overlap each other when projected in the width direction.

The EA portion 10 is disposed outside the vehicle frame 2 in the width direction and absorbs energy of a collision on a side of the vehicle 1.

According to the above-described embodiment, at least a part of the first portion 8 overlaps both of the battery cross portion 7 and the EA portion 10 when projected in the width direction. Consequently, the load applied to the EA portion 10 due to the collision on the side of the vehicle is supported is supported by the battery cross portion 7 via the first portion 8 and thus it is possible to improve an absorption efficiency of energy of the collision.

Similarly, according to the embodiment, at least a part of the second portion 9 overlaps both of the battery cross portion 7 and the EA portion 10 when projected in the width direction.

Consequently, the load applied to the EA portion 10 due to the collision on the side of the vehicle is supported is supported by the battery cross portion 7 via the second portion 9 and thus it is possible to improve the absorption efficiency of energy of the collision.

Further, since the load applied to the EA portion 10 due to the collision on the side of the vehicle is supported is supported by the battery cross portion 7, there is no need to increase a bending strength of the vehicle frame 2 in preparation for the collision on the side of the vehicle, it can be a simple configuration.

Further, according to the embodiment, the convex portions of the first portion 8 and the second portion 9 are positioned so as to overlap each other when projected in the width direction. Consequently, the load applied to the EA portion 10 due to the collision on the side of the vehicle is supported is supported by the battery cross portion 7 via the first portion 8 and the second portion 9, and thus it is possible to improve the absorption efficiency of energy of the collision.

Further, according to the embodiment, the ridge line along the upper end portion of each of the first portion 8 and the second portion 9 in the width direction coincides with the ridge line along the upper end portion of each of the battery cross portion 7 and the EA portion 10 in the width direction. As a result, a deviation between the position where the EA portion 10 extends in the width direction and the position where the battery cross portion 7 extends in the width direction is small in the front-rear direction of the vehicle 1, and thus it is possible to improve the absorption efficiency of energy of the collision.

According to the present disclosure, it is possible to realize a battery mounting structure capable of improving energy absorbing performance with a simple configuration.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A battery mounting structure comprising:
a vehicle frame having a hollow structure extending along a front-rear direction of a vehicle on both sides of the vehicle;
a plurality of battery modules arranged inside the vehicle frame and arranged along the front-rear direction and a width direction orthogonal to the front-rear direction;
a battery cross portion extending along the width direction in the vehicle frame;
an energy absorption portion arranged outside the vehicle frame in the width direction, the energy absorption portion being configured to absorb energy of a collision on a side of the vehicle; and
a first portion arranged between the battery cross portion and the vehicle frame to at least partially overlap both of the battery cross portion and the energy absorption portion when projected in the width direction.

2. The battery mounting structure according to claim 1, further comprising a second portion arranged in the hollow structure of the vehicle frame to at least partially overlap both of the battery cross portion and the energy absorption portion when projected in the width direction.

3. The battery mounting structure according to claim 2, wherein
the first portion and the second portion have convex portions protruding toward an outside of the vehicle in the width direction, and
the convex portions are positioned so as to overlap each other when projected in the width direction.

4. The battery mounting structure according to claim 2, wherein, a ridge line along an upper end portion of each of the first portion and the second portion in the width direction coincides with a ridge line along an upper end portion of each of the battery cross portion and the energy absorption portion in the width direction.
